(19) United States
(12) Patent Application Publication
(10) Pub. No.: US 2026/0109823 A1
(43) Pub. Date: Apr. 23, 2026

(54) PACKAGING BIOMATERIAL AND METHOD FOR MANUFACTURING THEREOF

(71) Applicant: KYIV INSTITUTE OF BIOTECHNOLOGIES, Kyiv (UA)

(72) Inventors: Alikin Oleksii Oleksiiovych, Kyiv (UA); Samokysh Oleksandr Hryhorovych, Kyiv (UA)

(73) Assignee: KYIV INSTITUTE OF BIOTECHNOLOGIES, Kyiv (UA)

(21) Appl. No.: 19/081,052

(22) Filed: Mar. 17, 2025

(30) Foreign Application Priority Data
Oct. 18, 2024 (UA) A202404976

(51) Int. Cl. C08J 5/04; B65D 65/46; C08J 3/12; C08J 3/28; C08K 3/26; C08K 3/34; C08K 5/05; C08K 7/02; C08L 89/00

(52) U.S. Cl. CPC C08J 5/045; B65D 65/466; C08J 3/12; C08J 3/28; C08K 3/26; C08K 3/346; C08K 5/05; C08K 7/02; C08L 89/005; C08K 2003/265

(57) ABSTRACT

A packaging biological material and to a method for manufacturing thereof uses residues of annual agricultural plants, where said material may be used for packaging industrial, food, cosmetic, and other various goods, as well as a building material. The packaging material may include cellulose fibers, and it further comprises clay, calcium carbonate (CaCO₃), natural glycerol, natural gelatin, at least one additional natural polymer and water. A method for manufacturing a packaging biomaterial includes grinding a fibrous cellulose material comprising corn tops, boiling the ground fibrous cellulose material together with additional components, forming a resultant mass and drying the biomaterial, while sunflower straw and tops are further used as the fibrous cellulose material, and clay, calcium carbonate (C-CaCO₃), natural glycerol, natural gelatin, at least one additional natural polymer and water are used as the additional components.

This application claims the benefit of Ukranian Patent Application a202404976, filed Oct. 18, 2024, the disclosure of which is incorporated herein by reference.

### TECHNICAL FIELD

This disclosure relates to a packaging biological material and to a method for manufacturing thereof using residues of annual agricultural plants, wherein said material may be used for packaging industrial, food, cosmetic, and other various goods, and as a building material.

### BACKGROUND

In modern world, there is an increasing attention to environmentally friendly and stable methods for manufacturing packaging materials having 100% of biodegradation. Traditional manufacturing is mainly based on use of wood that results in reduction of forest resources and negative impact onto the environment. This is particularly relevant in manufacturing a packaging paper, a cardboard, bottles, boxes, since they are products with a constantly increasing demand in view of increase of sales volume and requirements to enhance the environmental friendliness of the packaging.

A response to these challenges is use of alternative sources of raw materials such as residues of annual plants. Use of these materials allows not only to save the forest resources, but also to reduce a volume of agricultural wastes and CO₂ emissions, thereby making this approach environmentally friendly and economically feasible. For example, in order to manufacture 1 ton of paper, the following components are required: 5.6 m³ of wood that is equivalent to 17 trees; between 30 and 150 tons of water; 4 MWt of electrical energy, 240 l of a fossil fuel. This process utilizes chemicals that must be purified and disposed of, while CO₂ emissions take place, and they constitute about 30 kg.

Owing to latest technologies for processing fibrous plant materials, the residues of annual plants in countries having relative high quantities of agricultural residues of annual yields become perspective industrial raw materials for manufacturing a packaging biomaterial that, in terms of its properties such as rigidity, stability against external effects, and environmental safety, is as good as paper and cardboard made of wood, and as some types of plastics.

Patent RU2142877, teaches a method for producing composite materials such as a cardboard, the method comprises steps of preparing a fibrous lignocellulosic material being residues of annual plants, processing the residues of annual plants with water or vapor at a temperature between 40 and 120° C., simultaneous or sequential high-shear processing the residues of annual plants, heating and pressing the processed residues of annual plants in a presence of a bonding agent being a resin. Typical bonding agents listed in the specification of this invention are amino resins, phenol resins, resorcinol resins, tannin resins, isocyanate adhesives or mixtures thereof. Therefore, said resins are synthetic or partially synthetic bonding substances comprising aggressive chemical components such as formaldehyde. It means that these resins may have environmental consequences and cause health hazard due to their release during use of the product or manufacturing thereof.

A patent document KR20010077423 teaches a method for manufacturing a regenerated cellulose fiber using a rice straw. According to this method, the regenerated cellulose fiber is produced by steps of grinding the rice straw; boiling the ground rice straw in a diluted acid for 50-80 minutes followed by dewatering and washing; boiling with sodium hydroxide and sodium sulfide for 90-120 minutes followed by dewatering and washing; extracting an ingredient pulp; obtaining a molten cellulose that is subjected to bleaching and increasing the content of α-cellulose by means of a bleacher and sodium hydroxide; and dissolving the molten cellulose by a solvent system N-methyl morpholine-N-oxide/H₂O.

Therefore, the method requires the use of the diluted acid, sodium hydroxide and sodium sulfide that are aggressive chemicals. It increases manufacturing costs, requires special equipment to handle with corrosion substances, as well as may result in contamination of water and soil, if no relevant measures for purifying sewage water and wastes are provided. Also, synthetic bleachers are used for bleaching that may cause formation of by-products and requires additional steps for purifying sewage waters in order to avoid ecological consequences due to their potential toxicity.

A method for producing a packaging biomaterial from corn stems and a packaging material produced by this method is disclosed in the patent RU2249636. This method comprises steps of grinding the corn stems, their boiling, beating, dispersing, forming a resultant mass and drying the biomaterial. The boiling step is performed at a ratio between an aqueous reagent solution and a stem material of 6:1, at a reaction temperature between 120 and 200° C., during between 1.5 and 4 hours, and the boiling step represents sulfate boiling, sulfite boiling, alkaline or sodic boiling. In this way, the biomaterial comprising a sodic cellulose, a sulfate cellulose and an alkaline sulfite cellulose is produced.

The types of the boiling step include use of additional aggressive chemicals such as sodium hydroxide (alkali), sulfates and sulfides that causes problems of waste processing and requires additional costs for purifying sewage waters, thereby reducing the environmental friendliness of the process. Therefore, this manufacturing process may have negative consequences for the environment, if the purifying processes are not sufficiently effective, and increases risks for health of employees. Inorganic components and chemical residues that are not subjected to complete biodegradation may remain in the material.

In order to reduce the negative impact onto the environment, it is desirable to control the process for removing chemicals and residues, as well as to look for more environmentally pure processing technologies using reagents that are easier to decompose or leave no harmful by-products.

### SUMMARY

Thus, an objective of the present disclosure is to provide a packaging material having a composition that could ensure achievement of a technical effect that lies in a complete biodegradation of said material and, therefore, in avoiding its negative impact onto the environment.

Furthermore, another objective of the present disclosure is to provide a method for manufacturing a packaging material having main steps that could ensure achievement of a technical effect that lies in elimination of harmful manufacturing by-products, in production of a biomaterial with a possibility of its complete biodegradation and, therefore, in elimination of a negative impact of the manufacturing steps and the manufactured biomaterial itself onto the environment, while using renewable sources of cellulose for manufacturing said material.

The objective may be achieved by developing a packaging material comprising cellulose fibers that is characterized in that it further comprises clay, calcium carbonate (CaCO₃), natural glycerol, natural gelatin, at least one natural polymer and water.

Furthermore, the objective may be achieved by developing a method for manufacturing a packaging biomaterial, the method comprises steps of grinding a fibrous cellulose material comprising corn tops, boiling the ground fibrous cellulose material together with additional components, forming a resultant mass and drying the packaging biomaterial, while sunflower straw and tops are further used as the fibrous cellulose material, and clay, calcium carbonate (CaCO₃), natural glycerol, natural gelatin, collagen, at least one additional natural polymer and water are used as the additional components.

The sunflower tops and straw, as well as corn tops, represent a source of cellulose for the packaging biomaterial. They are renewable resources, since they are by-products of agricultural manufacturing process, as well as have industrial-scale production volumes. Use of these materials reduces dependence on wood and facilitates saving of forests, thereby making the manufacturing process more environmentally friendly.

Clay provides the packaging biomaterial with a certain plasticity degree, it is characterized by fire resistance, fusibility, and it is a waterproofing agent, while calcium carbonate acts as a filler. Said components are natural and non-toxic, thus, they are not harmful for the environment. They help to reduce use of synthetic additives, thereby also increasing the environmental friendliness of both the claimed manufacturing method and the manufactured product.

Natural glycerol acts as a viscosity regulator and stabilizer, thereby facilitating better mixing of the components of the material. Natural gelatin enhances binding properties of the components of the material and provides plasticity of the material. Both these substances are biodegradable, their use facilitates quick degradation of the packaging biomaterial in the natural environment, thereby reducing the ecological burden as compared to the synthetic binding agents.

The additional natural polymers are used in the composition of the biomaterial as binding components and components that provide rigidity and plasticity. It should be noted that since the cellulose is a natural polymer as well, but functions as the main filler, said polymers are intentionally called as additional polymers throughout this specification. Due to their origin, they are also biodegradable and non-toxic as well as other components, thereby increasing the environmental friendliness of the manufactured packaging biomaterial. Thus, they leave no harmful residues and do not contaminate soil and water resources.

Therefore, owing to use of the natural and renewable components in the composition of the biomaterial and during manufacturing thereof, the final biomaterial is environmentally friendly, easy to biodegrade and is not harmful for the environment. If this biomaterial gets in the soil, it will act as a natural fertilizer, while if it gets in salt or fresh water, it will decompose completely with no harm for living organisms that live in oceans, seas, lakes and rivers. The used components are relatively inexpensive, and the main components being the sources of the cellulose for the packaging biomaterial (corn and sunflower straw and tops) are prolific in Ukraine, while being in sufficient amounts in European countries and countries of Northern and South America. That is, the packaging biomaterial may be manufactured in industrial scale, while its manufacturing does not require to build any sewage purification plants.

### DETAILED DESCRIPTION

The most preferable embodiments of the claimed packaging biomaterial will be described herein below.

Preferably, the additional natural polymer is selected from a group comprising lignin, natural collagen and casein.

Lignin is comprised in cell walls of plants and helps them to ensure mechanical rigidity. Lignin can be decomposed naturally under action of microorganisms that are present in the soil. This facilitates reduction of accumulation of wastes and enhancement of natural ecosystems. Since lignin is obtained from a plant biomass, it may be considered as a renewable resource. This makes it a better alternative as compared to synthetic components. In a traditional paper manufacturing process, lignin is usually removed by natural processing (e.g., during bleaching), thereby producing additional wastes and requiring use of aggressive chemicals. Use of lignin in the composition of the packaging material allows to avoid any chemical intrusion, thereby positively affecting the environmental friendliness of the manufacturing method and the packaging biomaterial itself. Although lignin may cause after-yellowing of paper that is undesirable for certain types of products such as high-quality copy paper, this effect is not critical for more utilitarian materials such as the packaging biomaterial.

Collagen provides the packaging biomaterial with rigidity and elasticity, while casein is used as a binding component for other components of the biomaterial. Collagen and casein are natural polymeric materials that are obtained from animal raw materials (collagen is obtained from animal tissues, while casein is obtained from diary proteins). Since they origin from renewable sources, their use reduces dependency on synthetic polymers that are usually manufactured from petroleum. Both components are biodegradable. This means that the biomaterial that is manufactured with addition of collagen and casein does not result in a long-term contamination and easily integrates into a natural circulation of substances, thereby reducing the volume of wastes and their impact onto the environment. Finally, in contrast to some synthetic binding agents, casein and collagen are non-toxic agents, thereby making them environmentally safe. This reduces a risk of contamination of soil, water resources and negative impact onto health of humans and animals.

Clay may be at least one of white, red, blue, yellow or green clay. Each type of the clay provides the packaging material with a natural color, thereby allowing to provide the biomaterial having various shadings without use of any colorants. This is important in manufacturing of environmentally friendly and decorative biomaterials, where natural colors add an aesthetic value.

In the most preferable embodiment, the packaging biomaterial is characterized by the following quantitative composition, in wt. %:
cellulose fibers 30- 75
clay 5-25
calcium carbonate (CaCO₃) 3- 15
lignin 5-35
natural glycerol 2-20
natural gelatin 1-10
natural collagen 1-20
casein 3-25.

The selection of these ranges for the components in the composition of the packaging biomaterial can be explained by the necessity in achievement of an optimal balance between mechanical properties of the produced biomaterial and its purpose. Each of the components performs its own functions described above in the present specification, and its amount affects certain characteristics of the biomaterial.

Thus, a wide range of cellulose fibers allows to vary the amount of cellulose depending on a type of the packaging biomaterial, from a technical biomaterial to a decorative one. For example, for a lighter and less rigid packaging biomaterial, a lower percentage of the cellulose may be used, while for rigid packaging biomaterials, the amount of the cellulose may be as high as possible.

The amount of clay may vary depending on needs in smoothness and rigidity of the material. For a smoother and high-quality biomaterial, a greater amount of clay is used.

A lower amount of sodium carbonate is used for the packaging materials of a lower quality, while a greater amount thereof is used for more white and smooth products.

Selection of the lignin content depends on an importance degree of hardness and rigidity of the material. The higher lignin content may reduce manufacturing costs, but the excessively high amount may make the packaging material less flexible.

The higher lignin content makes the packaging material more elastic that is important for certain types of packaging biomaterials having a decorative effect.

Lower amounts of gelatin are used in materials, where economic efficiency is important, while higher amounts are used in cases, where the higher rigidity or stability against external effects is required.

Higher concentrations of collagen are used for biomaterials, where special requirements in terms of flexibility and rigidity are necessary, that are used for manufacturing special types of packaging: boxes, tubes, bottles, etc.

The higher amount of casein is used in biomaterials that require high rigidity and durability. Lower concentrations are suitable for lighter packaging products.

With regard to water, its minimum amount in the final packaging biomaterial allows to preserve its rigidity and integrity.

The most preferable embodiments of the claimed method for manufacturing a packaging biomaterial will be described herein below.

Most preferably, the ground fibrous cellulose material is treated with an ultraviolet radiation in order to remove mildew.

Furthermore, most preferably, the natural polymer is selected from a group comprising lignin, natural collagen and casein. Advantages of using these components are provided above in the present specification.

Most preferably, the implementation of the claimed method results in a packaging biomaterial that is characterized by the following qualitative and quantitative composition, in wt. %:
cellulose fibers 30-75
clay 5 - 25
calcium carbonate (CaCO₃) 3-15
lignin 5-35
natural glycerol 2-20
natural gelatin 1-10
natural collagen 1-20
casein 3-25.

In a preferable embodiment, the boiling step is performed in an autoclave during 2-6 hours at a temperature between 110 and 140° C. under pressure between 1.5 and 8 atm.

The lower duration of the boiling step is suitable for manufacturing biomaterials having lighter fibers or in order to preserve certain structural properties (e.g., for a packaging material having a lower density). The higher duration of the boiling step is necessary for achievement of better homogenization and rigidity of the biomaterial that is important for the packaging biomaterials having a higher density, where more time is required for uniform penetration of the components.

A lower temperature value allows to preserve certain properties of the fibers and avoid their excessive damage. This is applied to biomaterials, where flexibility and plasticity are important. A higher temperature value is used for more intensive processing, when maximum rigidity and stability of the biomaterial are required, e.g., for thick or technological cardboard, paper, boxes, bottles, cans. This temperature ensures effective decomposition of lignin and facilitates mixing with the additional components such as glycerol and collagen.

A lower pressure value may be used for materials having lower requirements as to rigidity, where it is necessary to preserve certain elastic properties. A higher pressure value allows to process denser fibers in a more efficient way and ensures a deeper penetration of reagents into the material, thereby making the final product more rigid and stable against external effects. This is important for the packaging biomaterials having high requirements as to rigidity.

Preferably, in the boiling step, 2-6 parts of water are used per 1 part of the fibrous cellulose material with the additional components.

Furthermore, in a preferable embodiment, the step of forming the resultant mass comprises pouring it into molds at a temperature of said mass of between 50 and 80° C. under pressure between 1 and 2 atm.

Said range of the temperature values ensures required fluidity and plasticity of the biomass for pouring, while said range of pressure values ensures uniform density and rigidity of the biomaterial, thereby enhancing binding of the fibers and removing air bubbles. These ranges are selected for achievement of a balance between the optimal processing of the biomaterial and preservation of properties of the natural components, thereby ensuring high quality of the final product.

Preferably, the step of drying the packaging biomaterial is performed at a temperature between 25 and 75° C. during 72-(4-6) hours respectively. The combination of the temperature and the drying time allows to set the process depending on the requirements as to the final product. If a more delicate approach for preservation of the natural properties of the material is required, lower temperatures and longer drying shall be used. In order to accelerate the process, higher temperatures and shorter time are used. Furthermore, the selection of higher temperatures from the range allows to reduce the process duration that may facilitate energy saving and increase of productivity.

One of specific embodiments of the claimed method for manufacturing the biomaterial, in particular, a cardboard packaging biomaterial, will be described herein below.

Firstly, 6 kg of the fibrous cellulose material comprising corn tops, straw and sunflower tops are ground to a powder state and treated with an ultraviolet radiation in order to remove fungi. Then, the ground material is mixed in a mixer with additional components, namely, 2 kg of clay, 0.5 kg of calcium carbonate (CaCO₃), 0.2 kg of natural glycerol, 0.3 kg of natural gelatin, 0.5 kg of lignin, 0.5 kg natural collagen, 0.5 kg of casein and 20 l of water. An order of mixing the materials has no importance. The obtained mixture is loaded into an autoclave and boiled during 4 hours at a temperature of 120° C. and under pressure of 3 atm. Then, the resultant mass is cooled down, preferably, owing to chilling thereof, and formed by pouring into molds at a temperature of said mass of 70° C. under pressure of 2 atm in a forming apparatus. The last step comprises drying the packaging biomaterial at a temperature of 22° C. during 36 hours.

Said method allowed to produce the cardboard packaging biomaterial having the following qualitative and quantitative composition, in wt. %:
cellulose fibers 60
clay 15
calcium carbonate (CaCO₃) 5
lignin 5
natural glycerol 2
natural gelatin 3
natural collagen 5
casein 5.

The produced cardboard packaging biomaterial is characterized by the following values of characteristics:
thickness is 0.5 mm,
density is 450 g/m².

In order to manufacture 1 ton of the claimed packaging biomaterial using the claimed method, up to 6 tons of water and up to 90 kWt of electrical energy are required, while in order to manufacture 1 ton of wood paper, as mentioned above, from 30 to 150 tons of water and 4 MWt of electrical energy are required.

The final biomaterial is used for packaging various industrial goods, food products in glasshouse, farmer and agricultural enterprises.

Thus, the packaging biomaterial that is characterized by complete degradation and, thus, lack of environmental impact, is developed. Furthermore, the method for manufacturing said packaging biomaterial is developed, the method is characterized by lack of harmful manufacturing by-products and use of renewable sources of cellulose at steps thereof.

Therefore, the packaging biomaterial is developed, and the composition of the packaging biomaterial allows achievement of the technical effect that lies in complete 100% biodegradation of said biomaterial and removal of its negative environmental impact.

Furthermore, the method for manufacturing said packaging biomaterial is developed, the method is characterized by lack of harmful manufacturing by-products and use of renewable sources of cellulose at steps thereof.

1. A packaging material comprising cellulose fibers, clay, calcium carbonate (CaCO₃), natural glycerol, natural gelatin, at least one additional natural polymer and water.

2. The packaging material according to claim 1, wherein the additional natural polymer is selected from a group comprising lignin, natural collagen and casein.

3. The packaging material according to claim 1, wherein clay is at least one of white, red, blue, yellow or green clay.

3. The packaging material according to claim 2, wherein clay is at least one of white, red, blue, yellow or green clay.

4. The packaging material according to claim 2, comprising a following quantitative composition, in wt. %:
cellulose fibers 30-75
clay 5-25
calcium carbonate (CaCO₃) 3-15
lignin 5-35
natural glycerol 2-20
natural gelatin 1-10
natural collagen 1-20
casein 3-25.

5. The packaging material according to claim 3, comprising a following quantitative composition, in wt. %:
cellulose fibers 30-75
clay 5-25
calcium carbonate (CaCO₃) 3-15
lignin 5-35
natural glycerol 2-20
natural gelatin 1-10
natural collagen 1-20
casein 3-25.

6. A method for manufacturing a packaging biomaterial, the method comprising the steps of:
grinding a fibrous cellulose material comprising corn tops,
boiling the ground fibrous cellulose material together with additional components,
forming a resultant mass, and
drying the packaging biomaterial,
wherein sunflower straw and tops are further used as the fibrous cellulose material, while clay, calcium carbonate (CaCO₃), natural glycerol, natural gelatin, at least one additional natural polymer and water are used as the additional components.

7. The method according to claim 6, further comprising the step of treating the ground fibrous cellulose material with an ultraviolet radiation.

8. The method according to claim 6, wherein the natural polymer is selected from a group comprising lignin, natural collagen and casein.

9. The method according to claim 8, wherein a resultant packaging biomaterial comprises a following qualitative and quantitative composition, in wt. %:
cellulose fibers 30-75
clay 5-25
calcium carbonate (CaCO₃) 3-15
lignin 5-35
natural glycerol 2-20
natural gelatin 1-10
natural collagen 1-20
casein 3-25.

10. The method according to claim 6, wherein the boiling step is performed in an autoclave during 2-6 hours at a temperature between 110 and 140° C. under pressure between 1.5 and 8 atm.

11. The method according to claim 6, wherein in the boiling step, 2-6 parts of water are used per 1 part of the fibrous cellulose material with the additional components.

12. The method according to claim 6, wherein the step of forming the resultant mass comprises pouring it into molds at a temperature of said mass of between 50 and 80° C. under pressure between 1 and 2 atm.

13. The method according to claim 6, wherein the step of drying the biomaterial is performed at a temperature between 25 and 75° C. during 72-(4-6) hours respectively.
